(19) United States
(12) Patent Application Publication
(10) Pub. No.: US 2006/0168575 A1
(43) Pub. Date: Jul. 27, 2006

(54) Defining a software deployment

(76) Inventors: Ankur Bhatt, Bangalore (IN); Karl Goger, Fussgonheim (DE); Aurobinda Pradhan, Bangalore (IN); Raghunandan S., Bangalore (IN); Rajeev Ranjan, Bangalore (IN)

Correspondence Address: KENYON & KENYON LLP, ONE BROADWAY, NEW YORK, NY, 10004, US

(21) Appl. No.: 11/040,290

(22) Filed: Jan. 21, 2005

(51) Int. Cl. G06F 9/44

(52) U.S. Cl. 717/168

(57) ABSTRACT

The present invention provides a system and method for generating instructions to deploy software by querying a user to configure a system portion and a process portion of the instruction set. Each portion may be stored in its own self-confined module of data, referred to as a system configuration and process configuration respectively. A system administrator may define an execution process that deploys software by linking one or more system configurations to one or more process configurations. The system configurations and process configurations may be stored indefinitely so that each portion can be reused for later software deployments involving different systems or process steps to be performed. A system administrator may set up system configurations, process configurations and execution process definitions using user-friendly graphical user interfaces.

### BACKGROUND

Information and computer technology comprises an essential component for modern business operations. Computer technology is constantly evolving providing customers with new services and improving existing services. Businesses enhance their existing computer software to provide improvements to end customers. This requires that new software be installed or that existing software be modified or upgraded to include the new enhancements.

Businesses may have many computers that operate together to provide customers with services. When a service is added or enhanced, these computers may require a new software installation or an upgrade of existing software. This may require installing new software or upgrading existing software on each computer used to provide the service. To install or upgrade software, an administrator may define steps to be performed to deploy software. A system administrator may be required to work with many different tools to define a software deployment. The resulting software deployment definition may be limited to deploying a particular software installation or upgrade and may be limited for use on a particular type of system. When the same software is to be deployed on another type of system, the system administrator may need to define a new software deployment and may not be able to reuse a portion of the previously defined software deployment. This is cumbersome especially for businesses that frequently install or enhance software on systems that operate using different operating systems.

### BRIEF DESCRIPTION OF THE DRAWINGS

FIG. 1 shows a generic software deployment network according to one embodiment of the invention.

FIG. 2 shows a mobile software deployment network according to one embodiment of the invention.

FIG. 3 shows a software deployment manager interface architecture according to one embodiment of the invention.

FIG. 4 shows an operation performed by a software deployment manager for deploying software according to one embodiment of the present invention.

FIG. 5 depicts client software deployment service interface architecture according to one embodiment of the present invention.

FIG. 6 shows the operation of a client software deployment service according to one embodiment of the invention.

FIG. 7 illustrates software deployment manager user interface components according to one embodiment of the invention.

FIG. 8 depicts a system configuration user interface according to one embodiment of the invention.

FIG. 9 depicts a process configuration view for configuring tasks according to one embodiment of the invention.

FIG. 10 depicts a process configuration view for configuring actions according to one embodiment of the invention.

FIG. 11 depicts an execution step definition view according to one embodiment of the invention.

FIG. 12 depicts a software deployment execution view according to one embodiment of the invention.

FIG. 13 shows a structure of a software deployment manager according to one embodiment of the invention.

### DETAILED DESCRIPTION

The present invention provides a system and method for generating instructions to deploy software by querying a user to configure a system portion and a process portion of the instruction set. Each portion may be stored in its own self-confined module of data, referred to as a system configuration and process configuration respectively. A system administrator may define an execution process that deploys software by linking one or more system configurations to one or more process configurations. The system configurations and process configurations may be stored indefinitely so that each portion can be reused for later software deployments involving different systems or process steps to be performed. A system administrator may set up system configurations, process configurations and execution process definitions using user-friendly graphical user interfaces.

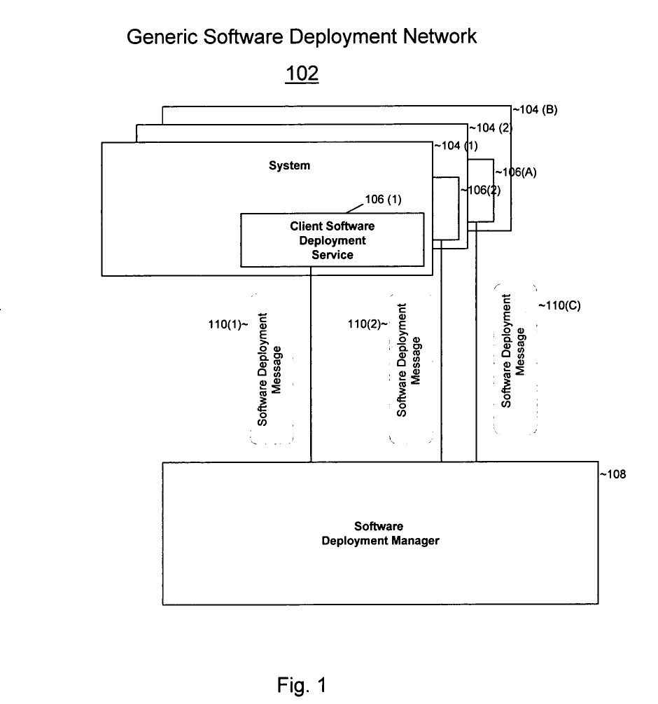

FIG. 1 shows a generic software deployment network 102 according to one embodiment of the invention. Generic software deployment network 102 may deploy software on any of systems 104 (1)-104(B), regardless of the operating system or software used by these systems by executing definitions previously set up by a system administrator. Generic software deployment network 102 comprises client software deployment services 106(1)-106(A) residing on systems 104(1)-104(B) and software deployment manager 108. Software is deployed on generic software deployment network 108 by transmitting software deployment messages 110(1)-110(C).

Software deployment manager 108 may deploy software on many systems because software deployment manager 108 remains independent of system 104, on which software will be deployed. Software deployment manager 108 remains independent of system 104 because client software deployment service 106 provides an interface to system 104 for the purpose of deploying software. Software deployment manager 108 may communicate with client software deployment services 106(1)-106(A) by transmitting software deployment messages 110(1)-110(C). Software deployment messages may comprise generic process steps or process configurations that point to locations of software installation packages. Each software deployment message 110 may also include system information, such as an address of a system on a network. Client software deployment service 106 translates software deployment message 110 and executes the software deployment. The software deployment may be executed by running the software installation package from the location where it is stored. The software installation may be stored in a directory on system 104 that typically stores installation software or may be stored at a location that is specified at run-time by a user.

System 104 may be any combination of one or more programmable processors and machine-readable medium that stores data. Machine-readable medium of system 104 may store computer code that will be modified in accordance with the deployment instructions provided by software deployment manager 108. After the software deployment is complete, the new or modified computer code will reside on system 104. Computer code may be implemented in any combination of any high-level procedural, object-oriented and/or assembly machine language.

Client software deployment services 106(1)-106(A) may be any computer code that communicates with software deployment manager 108 and translates commands received from software deployment manager 108 to execute a software deployment. In one embodiment of the invention, client software deployment service 106 is client software that resides on system 104. However, client software deployment services 106(1)-106(A) may reside in any machine-readable medium and may be processed by any programmable processor.

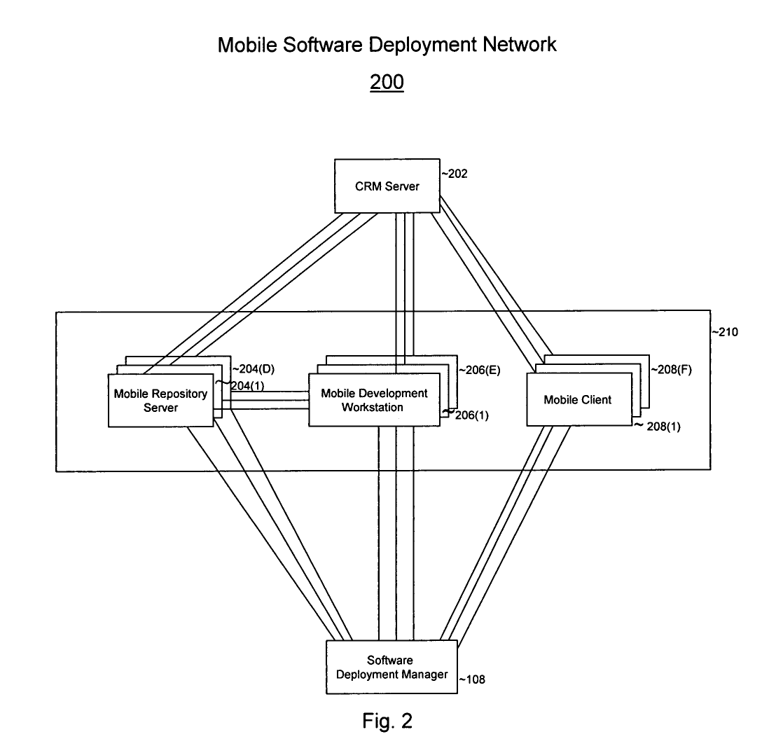

FIG. 2 shows an architecture for a mobile software deployment network 200 according to one embodiment of the invention. A mobile network may comprise many mobile clients 208(1)-208(F) that are operated in the field such as cellular telephones, personal data assistants, and laptop computers or any other device that provides customers with access data. Deploying software on mobile clients 208(1)-208(F) may be difficult since users may not want to bring mobile client 208 to an administrator to have software deployed thereby giving up benefits, such as the ability to travel and make contact from remote locations. Users may also not want to perform the software deployment themselves. Software deployment manager 108 may simultaneously deploy software on each of the devices of mobile software deployment network 200, including mobile clients 208(1)-208(F) that are remotely located. Users may avoid performing steps to deploy software, may be able to use their device in the field while the deployment is being run and may avoid incompatibility issues with upgraded systems that are not located in the field.

Mobile software deployment network 200 may comprise a customer relationship management (CRM) server 202, mobile environment 210, and software deployment manager 108. Mobile environment 210 may provide users of mobile clients 208(1)-208(F) access to services provided by CRM server 202. In one embodiment of the invention, CRM server 202 provides customer relationship management functions including marketing planning, campaign management, customer segmentation, other marketing analysis, sales planning and forecasting, sales organizational and territory management, account and contact management or other sales support or analysis.

Mobile environment 210 may comprise mobile repository servers 204(1)-204(D), mobile development workstations (MDWs) 206(1)-206(E), and the mobile clients 208(1)-208(F), which will receive a software deployment. Mobile repository servers 204(1)-204(D) may be connected to CRM server 202 to provide access to a mobile application repository (not shown), which comprises databases that provide mobile users access to various applications and also provides access to repository tools and services. Mobile development workstation 206 may be connected to mobile repository server 204 to provide development and administrative maintenance tools as well as access to a database of users. In one embodiment of the invention mobile repository server 204, mobile development workstation 206 and mobile client 208 operate with the Windows operating system. However, these devices may operate with any operating system and need not operate with the same operating system.

Software deployment manager 108 may be connected to mobile repository servers 204(1)-204(D), mobile development workstations 206(1)-206(E) and mobile clients 208(1)-208(F) to control the deployment of software on these devices by transmitting software deployment messages 110(1)-110(C). These connections may be wired or wireless, depending on the device, allowing, for example, mobile clients 208(1)-208(F) to be used in the field while receiving a software deployment. Software deployment manager may but need not be co-located with any of mobile repository servers 204(1)-204(D), mobile development workstations 206(1)-206(E) or mobile clients 208(1)-208(F) to deploy software on these systems. Upon receipt of a software deployment message 110, each client software deployment service 106 residing on mobile repository servers 204(1)-204(D), mobile development workstations 206(1)-206(E) and mobile clients 208(1)-208(F) may translate the message to deploy software. Client software deployment services 106(1)-106(A) may run in the background without user intervention but keep a user informed during processing.

Software deployment manager 108 recognizes hierarchies of systems that can receive deployed software. A “landscape” may be the highest entity within this hierarchy, which may represent an entire customer network with a set of environments within it. “Environments” may each be a logical set of system groups defined to ease management of software deployments by allowing a user to execute a software deployment to any of systems 104(1)-104(B) within the selected environment. For example, a user may select mobile environment 210 and execute a software deployment mobile repository servers 204(1)-204(D), mobile development workstation 206(1)-206(E) and mobile clients 208(1)-208(F) simultaneously. Mobile environment 210 may be within a mobile landscape that also includes, for example, a mobile development environment and a mobile test environment. “System groups” may be sets of systems chosen from systems 104(1)-104(B). Exemplary system groups are the group of mobile repository servers 204(1)-204(D), the group of mobile development workstations 206(1)-206(E), and the group of mobile clients 208(1)-208(F). Grouping systems in this manner allows software deployment on grouped systems to be handled in an efficient manner without significant user intervention.

Mobile software deployment network 200 can be implemented in a computing system that includes any combination of one or more back-end components (e.g., as data servers), middleware components (e.g., application servers), or front-end components (user interfaces). Connections in mobile software deployment network 200 can be realized in any form of circuitry and/or medium, including any wireless technology that allows transmission of digital data.

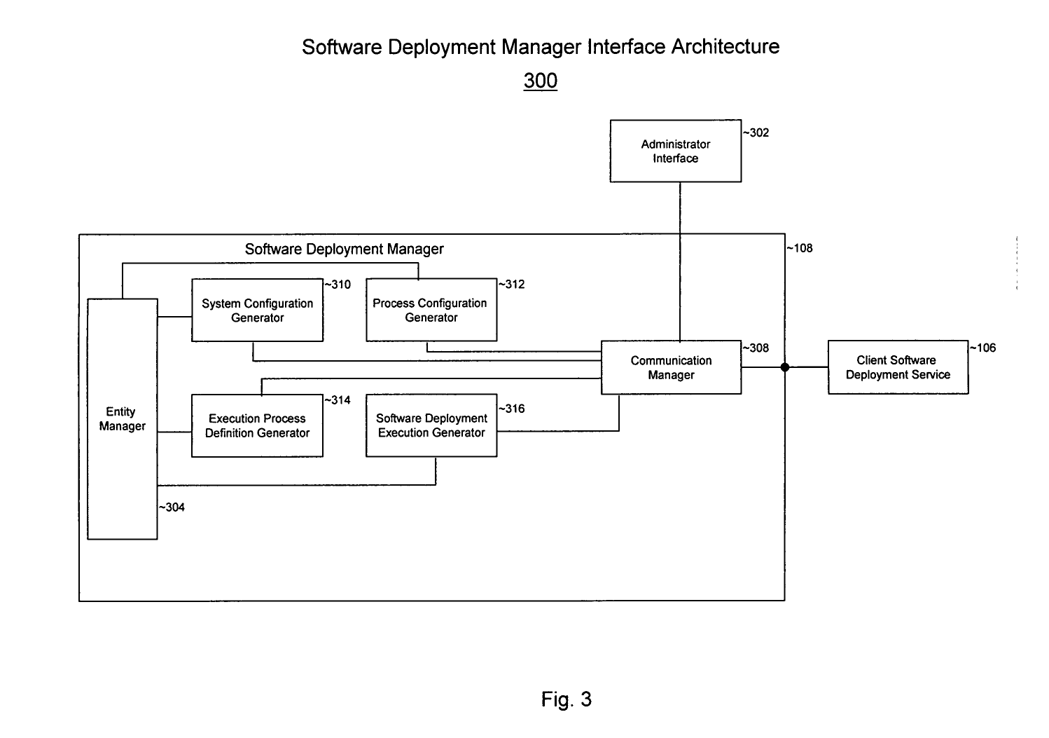

FIG. 3 shows a software deployment manager interface architecture 300 according to one embodiment of the invention. The software deployment manager interface architecture 300 comprises a software deployment manager 108 and entities that are connected to software deployment manager 108. In one embodiment of the invention, software deployment manager interface architecture 300 comprises administrator interface 302, software deployment manager 108, and client software deployment service 106.

Administrator interface 302 may be connected to software deployment manager 108 via communication manager 308 to allow a system administrator to set-up a software deployment using software deployment manager 108. Administrator interface 302 may provide a user interface to allow a user to setup the software deployment configurations and initiate execution. Administrator interface 302 may be any device that allows a system administrator to provide input to software deployment manager 108 and receive information from software deployment manager 108. Administrator 302 may be a client computer having a graphical user interface (GUI), a Web browser, a phone, or a personal data assistant) or any other device having an output device (e.g., liquid crystal display (LCD), cathode ray tube (CRT), or ear-piece) for displaying information to a user and/or an input device (e.g., keyboard, mouse, trackball, keypad) by which the user can provide input to the computer. Other types of administrator interfaces 302 may provide to the user any form of sensory feedback (e.g., visual feedback, auditory feedback, or tactile feedback) and receive from the user input in any form including acoustic, speech, or tactile input.

A software deployment manager 108 may comprise a system configuration generator 310, a process configuration generator 312 and an execution process definition generator 314 which are connected to a communication manager 308 for providing user interfaces to accept configuration information from a system administrator. System configuration generator 310, a process configuration generator 312 and an execution process definition generator 314 may also be connected to entity manager 304 to store configurations that are generated.

System configuration generator 310 may be query a user for information about an entity, such as system 104, and may store this information. Process configuration generator 312 may query a user to define executable units, including tasks, activities, processes or process groups that deploy software. Once the executable units and the entity are defined, the user may define the actual steps to be performed during the deployment by linking executable units to a configuration of the entity to be upgraded using the execution process definition generator 314. After the execution process has been defined, the user may initiate execution of the software deployment by, for example, selecting the appropriate control using the software deployment execution generator 316.

System configuration generator 310 provides a tool for setting up a configuration for system 104, as well as other groups with a hierarchy, such as system groups, environments, and landscapes. System configurations may comprise a system identifier, a system name, and an address on the network, such as an Internet Protocol address. System configurations may be stored in self-contained modules, such as objects for each entity, e.g., system, system group, environment or landscape. Objects may be stored for each entity that is defined. Entity manager 304 may manage these objects.

Process configuration generator 312 may query a user to characterize processes into different groups that will be executable units performed during run-time. Software deployment manager 108 may provide generic instructions to execute a software deployment. These generic instructions may include one or more executable units such as process groups, processes, actions and tasks. A “process group” may be a logical set of sequential processes that are performed on a type of system. A process group may represent a complete set of executable units to upgrade system 104. “Processes” may be executable units that perform a set of operations that leave a system 104 in stable condition after execution. A process group may be defined to include processes that depend on other processes to execute a software deployment. A user may group processes so that if one of the processes were to fail, subsequent processes included in the process group are not performed.

A process may be a logical group of actions or tasks that may be performed in a sequence to define the upgrade process. “Actions” may be logical groups of tasks that may be performed in a particular sequence. “Tasks” may be the most basic entity of the process hierarchy. A task is the basic unit of execution that can be defined using software deployment manager 108 and will be performed on a client software deployment service 106. A task is created from a command and can take a structure such as <TASK> - <COMMAND><PARAMETERS>. A command is the atomic operation of the definition of an operation. It signifies the operation that is performed at the time of execution. It may not contain information about the actual execution. Commands may be generic so that they may operate with different types of systems. In one embodiment of the invention, there is a fixed set of commands supported by an application. Each command is based on the operation it will perform. Below is a table listing some examples of commands and associated parameters:

| Command | Parameter | Description |
|---|---|---|
| Copy | File | Copies a file. |
| Delete | File | Deletes a file (only on the target). |
| Run | File | Runs a file as a new process. |
| Wait | | Waits for all processes to terminate. |
| Get | File | Copies a file to the SDM system |
| | | (e.g. because this file must be sent |
| | | to a different system). |
| Check | File, | Checks if Error-String exists in the |
| | Error- | file file. Used together with Stop/Loop |
| | String | on result. |
| Stop on | Output | If the process has terminated not with |
| result | Text | zero, the processing stops and the |
| | | output text is displayed until the user |
| | | continues the process in the management |
| | | tool manually. |
| Loop on | | If the process has terminated not with |
| result | | zero, the processing continues at the |
| | | top of the task definition. |
| End | | Stops the task processing. |

A parameter for a command may be the path to an installation, which may be specified as a pre-defined location where files will be installed or executed from or a tag that allows a user to supply the proper filename(s) when the software deployment is executed.

Process configuration generator 312 may be query a user to set up process configurations for the tasks that will be performed as well as defining other executable units, e.g., actions, processes and process groups. Process configurations may be stored as self-contained modules, such as objects for each executable unit, e.g., task, action, process or process group. An object may be stored for each executable unit that is defined. Entity manager 304 may manage these objects.

The execution process definition generator 314 may query a user to specify which of processes should run on which systems 104(1)-104(B) and link the appropriate process and system configurations. According to one embodiment of the invention, once users specify this link, the information is maintained so that users do not have to specify the link again. In one embodiment of the invention, a system administrator specifies a link using a user interface that allows selection of some of systems 104(1)-104(B) to be linked to a process or process group or selection of system groups to be linked to a process or process group. These links may be stored in the system using parent-child relationships between objects representing the linked entities. Since systems 104(1)-104 (B) can be grouped into system groups and environments, a single execution process definition can deploy new software or upgrade existing software any multiple systems within the system group or environment. This significantly reduces the burden of performing software deployment on systems that will process the deployment in the same manner.

Entity manager 304 may store system configurations, process configurations, and execution process definitions. Entity manager 304 may also retrieve data to provide user interfaces and to store data as a result of commands supplied by the user. Entity manager 304 may be connected to system configuration generator 310, process configuration generator 312 and execution process definition generator 314 to display user interfaces and perform processing as directed by an administrator.

The data associated with these entities is stored in storage 306. This data may be stored in one or more files such Extensible Markup Language (XML) files in the form of entity objects. According to one embodiment of the invention, data is stored in a Software Deployment Manager (SDM) metadata XML file. This SDM metadata XML file may store the name of each object and its attributes. SDM metadata XML file may also depict the relationships between various configurable objects. Entity objects that might store this data are described in the table below.

Structure of Configurable Objects

| Configurable | | |
|---|---|---|
| Object | Attributes | Relationships |
| Landscape | Landscape name, Id, | Environments (Child) |
| | Parentid, Loaded. | |
| Environment | Environment name, ID, | System groups (Child), |
| | Parentid, Loaded. | Landscape (Parent) |
| System Groups | System group name, Id, | Systems (Child), |
| | Parentid, Loaded | Execution Step (Child), |
| | | Environment (Parent) |
| Systems | Id, System name, System | System Groups (Parent), |
| | IP Address, InNetwork, | Execution Step (Child) |
| | Parentid, Loaded | |
| Command | Id, Parentid, Loaded, | Parameters (Child) |
| | Command name | |
| Task | Task name, Id, Command | Process (Parent), |
| | name, Parentid, Loaded | Action (Parent), |
| | | Parameters (child) |
| Parameters | Id, Parameter Name, | Tasks (Parent) |
| | Parameter Value, | |
| | Parameter placeholder | |
| | value, Parent id, | |
| | Loaded | |
| Action | Action name, Id, | Process (Parent), |
| | Parentid, Loaded. | Tasks (Child) |
| Process | Process name, Id, | Process group (Parent), |
| | Parentid, Loaded | Tasks (Child), |
| | | Actions (Child) |
| Process Groups | Process group name, | Processes (Child) |
| | Id, Parentid, Loaded | |
| Execution Step | Id, Parentid, Loaded | Processes (Child), |
| | | Process groups (Child), |
| | | System group (Parent), |
| | | System (Parent) |

Software deployment manager 108 may receive these selections and use object-oriented programming techniques, including parent-child relationships to represent the link. For example, a user may select from systems 104(1)-104(B) and indicate that these selections should be linked to a process group. Software deployment manager 108 may have these selections stored as system objects and a process group object. To identify which of systems 104(1)-104(B) are linked to process group, software deployment manager 108 may define the system objects representing the users selections to be children of the process group object.

Once an execution process definition is set up, a software deployment may be executed. Software deployment execution generator 316 may initiate execution of a new installation or upgrade. According to one embodiment of the invention, to start the execution, the user specifies a path where an installation is present and chooses the execution steps to be performed. An installation is a software package that is typically provided by the software and/or system manufacturer for installing the software onto a computer. The installation can be stored on a system that is receiving the deployment or on a remote system.

Software deployment message 110 may be generated to communicate information from the software deployment manager 108 to the client software deployment service 106. A software deployment message 110 identifies a system, for example, by providing an IP address, and also provides executable units that will be processed to deploy software and parameters of these executable units, such as a filename of an installation package. A software deployment message 110 may be sent to perform a particular execution step, comprising one or more interrelated executable steps. If an executable unit sent in a software deployment message 110 fails, subsequent steps transmitted in the software deployment message 110 may not be performed to avoid execution of steps that are dependent on the failed step. An administrator may design a software deployment to include multiple software deployment messages to divide up sets of interrelated tasks to protect against continued deployment in the event of failure of a necessary step while steps that are independent of others proceed. According to one embodiment of the invention, software deployment message 110 has a header and a detail part. The header contains information about the message. The detail part may contain actual instructions that will execute the upgrade. The header may hold information about the client system like the system address, name, current date and time, security related information. The detail part may hold information about process group or process to be executed including the individual tasks to be performed on system 104 to execute the software deployment. An exemplary software deployment message 110 is below:

<Header Name=”INLD50022871” IPAddress= “10.49.122.43” Date =
“11/01/2003”
Time =”00:12:12” EncryptionKey= “”>
</Header>
<ExecSteps Name=””>
<Process Name=””>

<Task11 Name=”Copy” Optional Param1=”” Optional Param2=””>
<Task12 Name=”Run” Optional Param1=”” Optional Param2=””>
<Task13 Name=”Delete” Optional Param1=”” Optional Param2=””>

</Process>
<Process Name=””>

<Task11 Name=”Copy” Optional Param1=”” Optional Param2=””>
<Task12 Name=”Run” Optional Param1=”” Optional Param2=””>
<Task13 Name=”Delete” Optional Param1=”” Optional Param2=””>

</Process>
</ExecSteps>

Software deployment manager 108 also comprises communication manager 308. Communication manager 308 may facilitate communication between software deployment manager 108 and external devices. For example, communication manager 308 may perform handshaking necessary to make sure that the external device is available to send and receive data. According to one embodiment of the invention, communication manager 308 is connected to the administrator interface 302 to receive commands from an administrator and to provide information to the administrator. Communication manager 308 may also be connected to entity manger 304 to provide information received from the administrator to the other elements of software deployment manager 108. Additionally, communication manager 308 may be connected to client software deployment service 106 to send messages to execute a software deployment and to receive messages providing status of a software deployment. Communication manager 308 may construct a software deployment message 110 to provide information to client deployment service 106.

Communication manager 308 may also provide security for the transmission of a software deployment message 110 as well as handling the transmission protocol e.g., Transmission Control Protocol/Internet Protocol (TCP/IP), which is a communications protocol developed to internetwork dissimilar systems and has become the global standard for communications. TCP provides transport functions, which ensures that the total amount of bytes sent is received correctly at the other end. The IP part of TCP/IP provides routing capability.

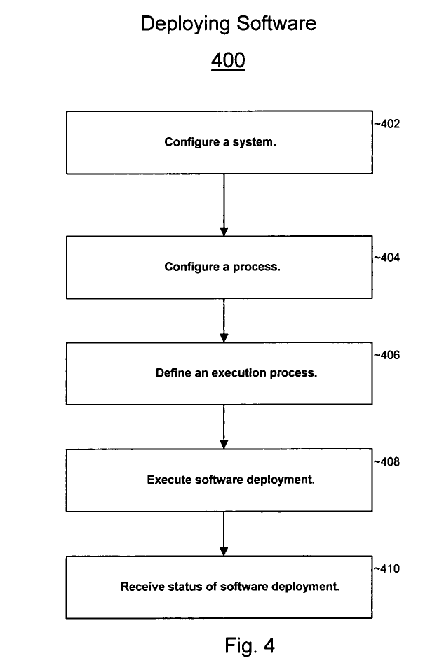

FIG. 4 shows the operation of a software deployment manager 400 according to one embodiment of the invention. In step 402, a user sets up a system configuration. Software deployment manager 108 accepts input from a user and stores a system configuration. Software deployment manager 108 may configure a system 104, system group, environment or landscape or any combination of these entities and may store these configurations as objects. For example, a user may provide a system name and system IP address for system 104. The relationship among the configurations can be established using parent-child relationships.

In step 404 a process is configured by software deployment manager 108. Software deployment manager 108 may configure a task, action, process, process group or any combination of these entities and store these configurations as objects. The relationship among the configurations can be established using parent-child relationships. Since the process configuration is independent of the system configuration, step 404 may be performed prior to step 402.

Software deployment manager 108 may receive a definition of a task in the form of <TASK> - <COMMAND><PARAMETERS>. This executable unit may run a file that executes a software installation package. For example, a user may configure a task to have the command “Run,” which includes as a parameter a file that contains the software installation package. A user may configure the file to be a pre-defined location such as a Windows Temporary Folder, a Mobile Client Installation Path, or a system drive. A user may store the installation package and/or any other files that will install or upgrade software. The package that is stored at the specified location will be run when the software deployment is executed. Alternatively, during configuration, a user may define a tag so that the proper filename(s) may be supplied when the software deployment is executed. These files may include installation software that installs or upgrades software on one or more systems that are receiving the software deployment.

A software deployment manager 108 may configure a process as comprising one or more interrelated tasks or actions. A process may be a set of computer instructions that when processed execute a software deployment. In an alternate embodiment of the invention, the software deployment manager 108 may configure a process group that comprises multiple interrelated processes, which when processed together execute a software deployment.

In step 406, an execution process is defined. Software deployment manager 108 may define an execution process by accepting user input specifying a link of a system definition or system group to a process group or a process. This link may be defined using an execution step object. The execution step object may include processes and process groups that are defined as children and system and system groups that are defined as parents. System configurations, process configurations and execution step definitions may each be stored indefinitely and used at any time. In an alternate embodiment of the invention, software deployment manager 108 can use a system configuration and/or a process configuration that was received by another processing system and downloaded to software deployment manager 108 to define an execution process.

In step 408, a software deployment is executed. Software deployment manager 108 may execute a software deployment by receiving input from a user requesting execution and issuing a software deployment message 110 to client software deployment service 106. The software deployment message 110 may comprise information received during configuration. Communication from software deployment manager 108 to client software deployment service 106 (or any other entity that assists in execution) may be in any form that is understood by both devices and is not limited to a software deployment message 110. Step 408 need not be performed within any specified period of time after steps 402 through 406.

To execute a software deployment, software deployment manager 108 may transmit software deployment messages 110(1)-110(C) to each system within the entity e.g., environment, system group or system that was selected by a user. Execution of a software deployment to many systems within a large entity may be efficient and may reduce incompatibilities among network components that interact with each other. Since software deployment manager 108 may be connected to components via a network, software deployment messages 110(1)-110(C) may be transmitted via the network to systems at remote locations. In one embodiment of the invention, software deployment manager 108 may search a database that maintains availability information to determine if a system is available, e.g., logged onto the network prior to transmitting a software deployment message 110 to that system. If a system is not available, software deployment manager 108 may hold the software deployment message 110 and then search the database again according to a preset interval. When the system becomes available, the software deployment manager 108 may then transmit the software deployment message 110.

In step 410, status is provided of the software deployment, for example, via a software deployment log message. A user may choose to receive a task level software deployment log message 110 or a process level software deployment log message 110. This allows the user to decide the level of detail of the status that will be provided. If the user wants to see the status for each task that is executed, the user may select to see a detailed task level status. If the user wants to see a higher level status, the user may select a process level status instead. In other embodiments of the invention, other levels of status may be provided. In one embodiment of the invention, client software deployment service 106 provides the user with the status. In an alternate embodiment of the invention, software deployment manager 108 provides the user with a status. Alternate embodiments of the invention are possible in which no status is provided to a user or both client software deployment service 106 and software deployment manager 108 provide users with statuses.

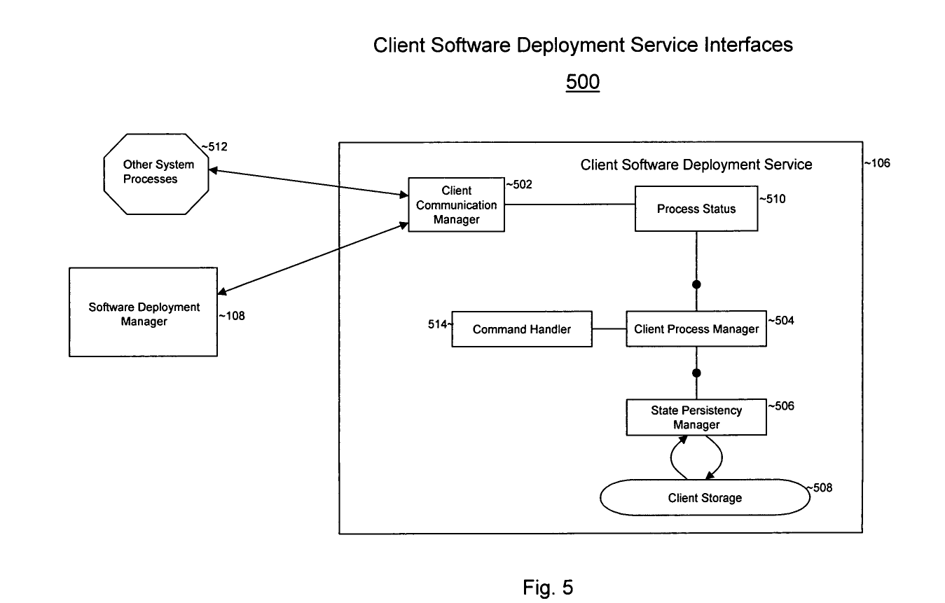

FIG. 5 depicts client software deployment service interface architecture 500 according to one embodiment of the present invention. Client software deployment service interface architecture 500 includes client software deployment service 106, software deployment manager 108 and other system processes 512. Client software deployment service 106 comprises client communication manager 502, process status 510, client process manager 504, command handler 514, state persistency manager 506 and client storage 508. Client communication manager 502 is connected to process status 510 to facilitate communications between the client software deployment service 106 and external systems. Process status 510 is connected to client process manager 504 to obtain information about the progress of the software deployment from the client process manager 504 and provide status to the user and/or to the software deployment manager 108. Client process manager 504 controls the software deployment and is connected to command handler 514 to receive translated messages and to state persistency manager 506 to send information regarding the current state of the software deployment so that it can be persisted. The state persistency manager 506 is connected to client storage 508 to store a persisted state.

Client communication manager 502 is connected to other system processes 512 of system 104 to deploy software on system 104. In an alternate embodiment of the invention, client communication manager 502 is connected to an external system 104 via, for example, a communication link or a network. Client communication manager 502 handles communications for client software deployment service 106. Client communication manager 502 is also connected to software deployment manager 108 to facilitate communications between software deployment manager 108 and client software deployment service 106. For example, client communication manager 502 may provide handshaking to indicate that client software deployment service 106 is ready to receive software deployment message 110.

Client software deployment service 106 performs upgrades by executing steps in software deployment message 110 sent to initiate the new installation or upgrade. Client software deployment service 106 also may provide the user with a status via a Tool Bar Icon and/or a dialog box. Process status 510 within client software deployment service 106 provides the user with a status of the upgrade. Process status 510 may act as a bridge between client communication manager 502 and client process manager 504 by receiving and sending information and collecting status information that will provide build a software development log message and/or providing an icon or dialog box with a status to a user. In one embodiment of the invention, the user is not given the option to stop the upgrade once the upgrade process has started.

Client process manager 504 is responsible for interpreting the software deployment message 110 and executing tasks one by one. It interacts with client communication manager 502 to receive messages from software deployment manager 108. Client process manager 504 calls command handler 514 to execute the message. Command handler 504 provides an interface between the software deployment manager 108 and the system 104. Command handler 504 can accept commands sent by software deployment manager 108 and, if needed, translate them to commands understood by system 104 so that they can be executed. Command handler 504 may perform this translation by using a look-up table residing in machine-readable medium on system 104. Command handler 504 may search this look-up table for the generic command retrieved from software deployment message 110 and retrieve a corresponding system compatible command from the look-up table. An exemplary look-up table is below.

| | System | |
|---|---|---|
| Generic | Compatible | |
| Command | Command | Description |
| Copy | Retrieve copy | Copies a file. |
| Delete | Purge | Deletes a file (only on the target). |
| Run | Start | Runs a file as a new process. |
| Wait | Hold | Waits for all processes to terminate. |
| Check | Search | Checks if Error-String exists in the |
| | | file file. Used together with Stop/ |
| | | Loop on result. |
| Stop on | Halt Processing | If the process has terminated not with |
| result | | zero, the processing stops and the |
| | | output text is displayed until the |
| | | user continues the process in the |
| | | management tool manually. |
| Loop on | Continue | If the process has terminated not with |
| result | Processing | zero, the processing continues at the |
| | | top of the task definition. |
| End | Terminate | Stops the task processing. |
| | Processing | |

For example, if software deployment manager 108 sends a software deployment message 110 with a command “Run” and an associated parameter, command handler 514 can interpret “Run” using operating system commands of system 104. If, for example, the command corresponding to “Run” on system 104 is “Start,” command handler 514 executes a start using the associated parameter transmitted in the software deployment message 110.

In an alternate embodiment of the invention, the look-up table may reside in machine-readable medium on another programmable device that may be accessed by system 104. The look-up may be performed by first translating the system IP address to determine the type of system that is requesting translation and then searching for a look-up table that corresponds to the type of system that requests translation. Alternatively, when client software deployment service 106 requests translation, it may include the type of system requesting translation in its request.

During and after processing a software deployment message 110, client process manager 504 may provide a status to software deployment manager 108. Exemplary statuses are provided below.

| Status | Description |
|---|---|
| Running | The task is being executed. |
| Waiting | The task is in waiting while the system processes |
| | another task. |
| Success | The task was successfully executed. |
| Failure | Execution of the task failed. |
| Stop | A system administrator chose to stop execution. |

Client process manager 504 interfaces with state persistency manager 506 to persist its state. State persistency manager 506 preserves the state of the client software deployment service 106 so that status of the installation or upgrade can be provided. The state of client software deployment service 106 may be persisted because client software deployment service 106 may be prone to exceptions due to its execution of different processes. Persisting the state of client software deployment service 106 allows client software deployment service 106 to communicate its state to software deployment manager 108 even if a process that is being executed fails.

According to one embodiment of the invention, process status 510 may create a software deployment log message to provide the status to software deployment manager 108. The software deployment log message may provide the status of the tasks, which are performed on the client, including the success/failure of each task, and inform the software deployment manager 108 whether the software deployment was successful or not.

The software deployment log message may comprise a header that holds information such as server name, start date and time, end date and time, and information related to encryption/decryption and a detail part containing information about the success or failure of tasks or processes. According to one embodiment of the invention, two types of software deployment log messages may be transmitted. The messages may have the same header. However, the detail part may be different. The two types of messages are outlined below.
1. Task level message—The task level message is submitted to software deployment manager 108 after completion of every task.
2. Process level message—The process level message is submitted to software deployment manager 108 after completion of each process. The process level message may have task level details.

According to one embodiment of the invention, a user chooses the type of software deployment log message to be transmitted. Below is an exemplary software deployment log message.

<Header Name=”INLD50022851” IPAddress= “10.49.122.13” Date =
“11/01/2003”
Time =”00:12:12” EncryptionKey= “”>
</Header>
<Log>
<Process1=””>

<Task11 Name=”Copy” Status=”S” StartDateTime = “”
EndDateTime = “”/>
<Task12 Name=”Run” Status=”S” StartDateTime = “”
EndDateTime =””/>
<Task13 Name=”Delete” Status=”F” StartDateTime = “”
EndDateTime = ”” >

<Log>LogFile.zip </Log>

</Task13>

</Process>
<Process2=””>

<Task21=”Copy” Status=””/>
<Task22=”Run” Status=””/>
<Task23=”Delete” Status=””/>

</Process>
</Log>

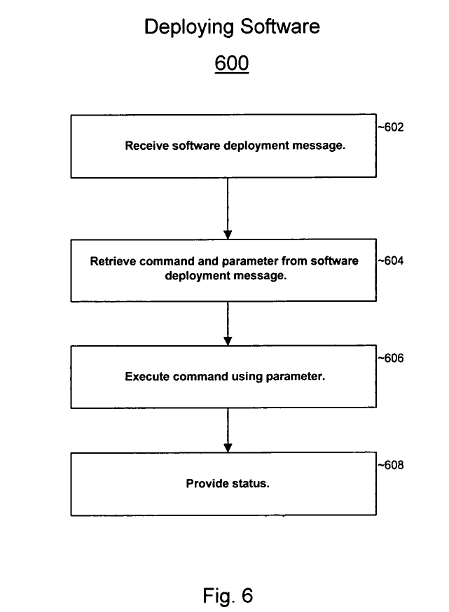

FIG. 6 illustrates the operation of a client software deployment service 106 according to one embodiment of the invention. A client software deployment service 106 may execute software on system 104. Client software deployment service 106 may assist in the execution by providing an interface between software deployment manager 108, which is neutral of the system 104, which is receiving the software deployment.

In step 602, a software deployment message 110 is received by client software deployment service 106. Client communication manager 502 receives the software deployment message 110 and sends it to client process manager 504.

In step 604, client process manager 504 parses the software deployment message 110. Client process manager 504 may perform initial checking to ensure that a valid software deployment message 110 was received and system 104 was the intended destination of the software deployment message 110. Client process manager 504 may send a command and parameter received in the software deployment message 110 to command handler 514.

In step 606, command handler 514 executes the command received in the software deployment message 110. Command handler 514 may translate the command by checking a lookup table that provides operating system commands of system 104 that correspond to commands transmitted by the software deployment manager 108. Command handler 514 notifies client process manager 504 of the result of the execution.

In step 608, client software deployment service 106 provides a status of the software deployment. Client process manager may provide a status to process status 510. Process status 510 may provide a status of the software deployment by, for example, providing a short message on a Tool Bar Icon and/or a dialog box. Process status 510 may also create a software deployment log message and transmit this message to software deployment manager 108.

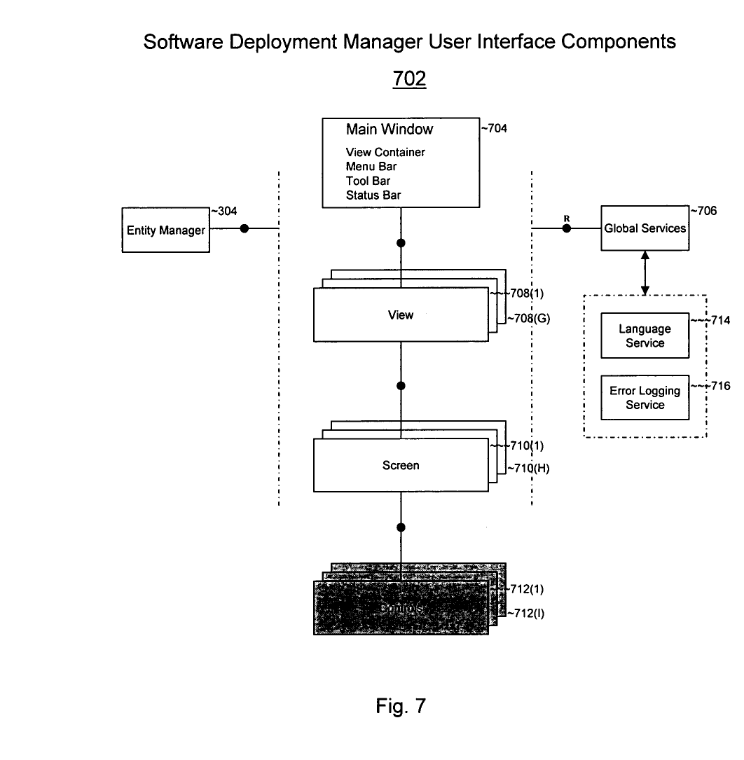

FIG. 7 illustrates software deployment manager user interface components 702 according to one embodiment of the invention. In one embodiment of the invention, software deployment manager user interface components 702 provide graphical user interfaces for an administrator using administrator interface 302.

Software deployment manager user interface components 702 provide user interfaces that are displayed to an administrator on administrator interface 302 so that the administrator can configure systems and processes, define execution processes and execute a software deployment. Software deployment manager user interface components 702 comprise entity manager 304, main window 704, and global services 706.

Main window 704 comprises views 708(1)-708(G), screens 710(1)-710(H), and controls 712(1)-712(I). Views 708(1)-708(G), screens 710(1)-710(H), and controls 712(1)-712(I) may be within a view container. Main window 704 is responsible for overall flow and will host different views based on user choice. Main window 704 may act as a host. Main window 704 provides the framework in which the user interface will be loaded. Main window 704 may display a menu bar, tool bar, and/or status bar.

Within main window 704 is the option to load different views 708(1)-708(G). Views 708(1)-708(G) host screens, communicate between screens, and communicate from main window 704 to individual screens 710(1)-710(H). Each of views 708(1)-708(G) will have different screens 710(1)-710(H) that will represent different sections of the user interface.

Screens 710(1)-710(H) host and load controls 712(1)-712(I) from an entity object model that is controlled by entity manager 304. Screens 710(1)-710(H) also handle actual operations that a user performs on controls 712(1)-712(I).

Controls 712(1)-712(I) provide the user with the ability to control the software deployment process and allow a user to configure systems and processes, define execution processes and execute a software deployment. A user manipulates an input device to select among options provided by controls 712(1)-712(I) to affect processing performed by software deployment manager 108.

Global service 706 performs general functions necessary to provide a GUI interface. Global service 706 provides access to language service 714, so that, for example, a user can select a language for the display, and error logging service 716, so that errors that occur during processing can be correctly logged.

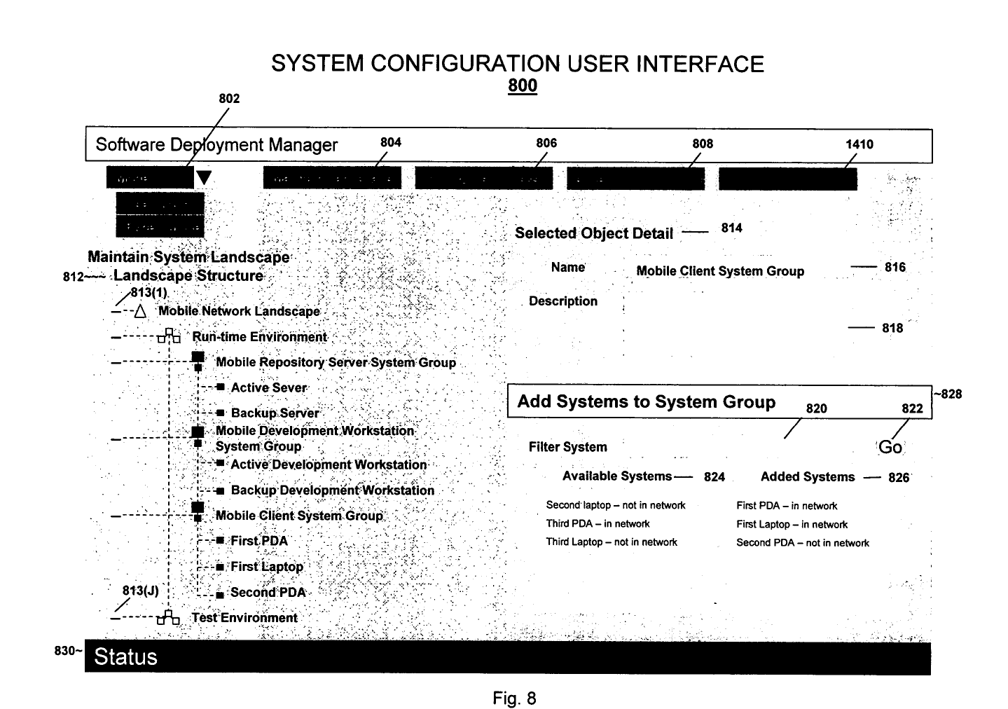

FIG. 8 depicts a system configuration view 800 according to one embodiment of the invention. System configuration view 800 may comprise maintain system landscape screen 812, select object detail screen 814 and add systems to system group screen 828. Main window 801 may also be displayed along with system configuration view 800.

Main window 801 may include identification bar 803 to identify that the user interface is being displayed by the software deployment manager 108. Main window 801 may also include a mode control 802 that allows a user to select a mode of operation. For example, a user may select an “expert mode” that allows the user to access all of the user interface screens or a “user mode” that limits access to user interfaces for initiating the actual software deployment. Only certain users may be allowed access to user interface screens that are associated with expert mode. In expert mode, experts or administrators may set up system configurations and process configurations and to define execution steps. In user mode, other users may initiate software deployments. Main window 801 may also include maintain landscape control 804, configure process control 806, define execution steps control 808, and execute control 810. Landscape control 804 causes system configuration view to be displayed. Configure process control 806, define execution steps control 808, and execute control 810 cause other views to be displayed.

Maintain system landscape screen 812 may include a list of landscapes maintained by software deployment manager 108. Each entity listed by maintain system landscape screen 812 may include expansion controls 813(1)-813(J) that displays a plus sign. When a user clicks on expansion control, entities within the parent entity are displayed and a minus sign is displayed in place of the plus sign. For example, if a user selects expansion control 813(1), environments within the mobile network landscape may be displayed. A user may select any entity within the displayed landscapes. Maintain system landscape screen 812 may retrieve entities using parent-child relationships between objects representing these entities that may be stored and managed by entity manager 304.

Select object detail screen 814 displays details of an entity selected using maintain system landscape screen 812. The object that stores the data associated with this entity may be retrieved using entity manager 304. The name of the entity that is selected is displayed by name control 816 and the description of the entity is displayed by description control 818. For example, if mobile client system group is selected, the phrase “mobile client system group” will be displayed by name control 816 and the description of this group will be displayed by description control 818. Select object detail screen 814 may also query a user to add a new entity. In this case, a name and description of the new entity are added.

Add systems to system group screen 828 displays entities that are within the parent entity selected and available additional entities that may be added. Add systems to system groups screen 828 may include available systems control 824, added systems control 826, filter system control 820 and filter system go button 822. Added systems control 826 displays systems that have been added to the system group and indicates whether these devices are currently logged into the network or not logged into the network. These systems may be selected and deleted by a user. If systems listed by added systems control are deleted by a user, they will no longer be part of mobile client system group. Available systems control 824 displays available systems in the network and indicates whether these devices are currently logged into the network or not logged into the network. A user may select any system of available systems listed by available systems control 824. Alternately, a user may search for available systems using filter system control 820. Searching for available systems may be particularly useful when many systems are available and the user does not wish to scroll through all of them. After typing text in filter system control 802, a user may press the filter system go button 822. A search will be performed of available systems and only those systems that meet the criteria provided using filter system control 820 will be displayed by available systems control 804.

Information describing the availability of systems on a network may be retrieved and searched to identify available systems to display to the user. For example, a network may have software that monitors devices attached to the network to identify performance problems and system failures. Software deployment manager 108 may query the network to obtain a list of systems connected to the network and/or to search these systems using criteria specified via, for example, filter system control 820. In response to the query, the software deployment manager 108 may receive a list of systems that are connected to the network and, for example, information indicating whether the system is logged onto the network. The software deployment manager 108 may display this list or may perform a search based on user-specified criteria. Alternatively, a subset of systems retrieved as the result of the search may be sent to software deployment manager 108 and displayed to the user.

If an environment or landscape is selected using maintain system landscape screen 812, and add system groups to environment screen or add environments to landscape screen may be displayed. Within add system groups to environment screen an available system groups and an added system groups control will be displayed. Within an add environments to landscape screen an available environments control is displayed as well as an added environments control. Selected system groups and environments may also be filtered using a filter system group control or a filter environment control.

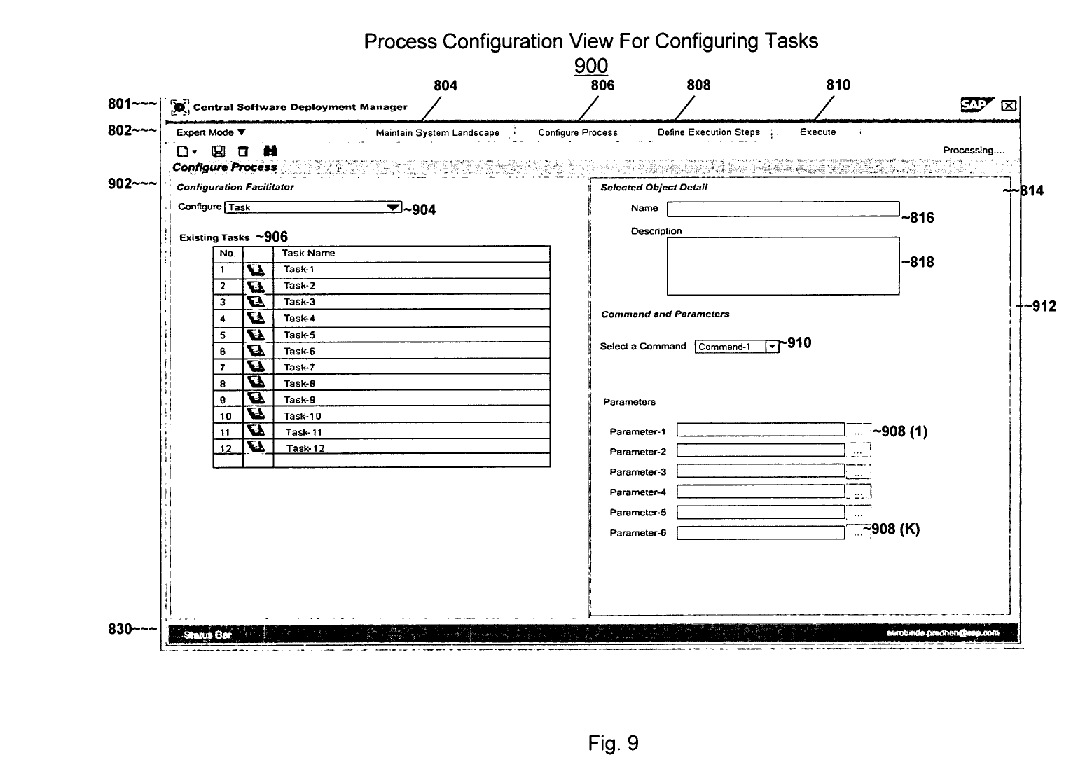

FIG. 9 depicts a process configuration view for configuring tasks 900 according to one embodiment of the invention. Main window 801 may also be displayed along with process configuration view for configuring tasks 900. Process configuration view for configuring tasks 900 may include configuration facilitator screen 902, select object detail screen 814, and command and parameters screen 912.

Configuration facilitator screen 902 may include configure control 904 and existing executable units control 906. Configure control 904 may provide a user with selections of types of executable units to configure, such as task, action, process, and process group. A user selects the type of executable unit that the user wishes to configure. Existing executable units control 906 displays existing executable units of this type. For example, if task is selected using configure control 904, existing executable units control 906 displays existing tasks. Existing executable units control 906 may retrieve the existing executable units using objects stored by entity manager 304. A user may select one of the existing executable units to modify. Select object detail screen 814 displays the name and the description of the executable unit that was selected. If no executable units are selected, a user may add a name and description of a new executable unit to be added using select object detail screen 814.

Command and parameters screen 912 may be displayed when a user selects a task using configure control 904. Command and parameters screen 912 may query a user to select a command and provide associated parameters. Select a command control 910 provides commands that a user may select from such as copy, delete, run, wait, get, check, stop on result, loop on result, and end. When selected by a user, parameter controls 908(1)-908(K) may enter parameters associated with the command selected.

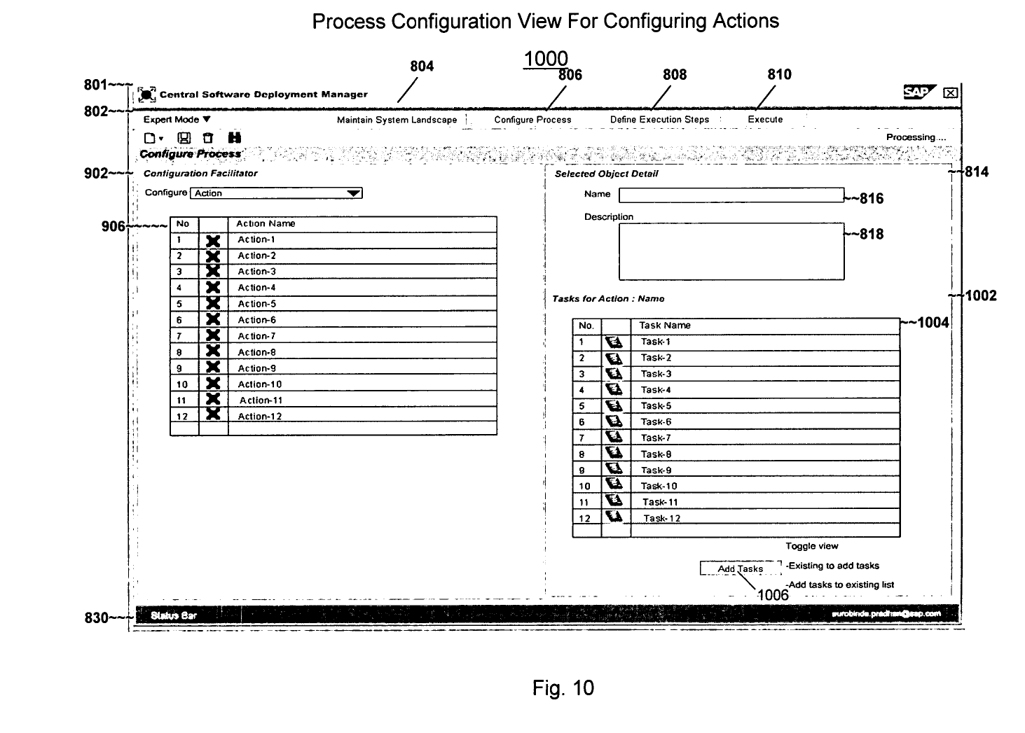

FIG. 10 depicts a process configuration view for configuring actions 1000 according to one embodiment of the invention. Main window 801 may also be displayed along with process configuration view for configuring actions 1000. Process configuration view for configuring actions 1000 may include configuration facilitator screen 902, select object detail screen 814, and select executable units screen 1002. Select executable units screen 1002 may include available executable unit display 1004 and add executable unit control 1006. Available executable unit display 1004 displays available executable units that would be children of the executable unit selected using configuration facilitator screen 902. These may be retrieved from objects stored using entity manager 304. For example, configure control 904 provides executable units that may be selected by a user. If a user selects action, available executable unit display 1004 displays tasks that may be assigned to an action. A user may add one or more executable units by selecting the add executable unit control 1006. For example, if a user wished to add a task, the user may simply select any tasks to be added using executable unit display 1004 and then chose to add tasks using add executable unit control 1006.

Process configuration views for configuring processes and process groups may also be displayed. Executable unit display 1004 may display tasks or actions. Additionally, if the process configuration view is for configuring process groups, executable unit display 1004 may display processes. The user may select any of the executable units displayed by executable unit display 1004 and add them to the process configuration by selecting the add executable unit control 1006. A user may delete an executable unit by selecting the executable unit and indicating that the selection should be deleted by, for example, selecting a delete button on a keyboard.

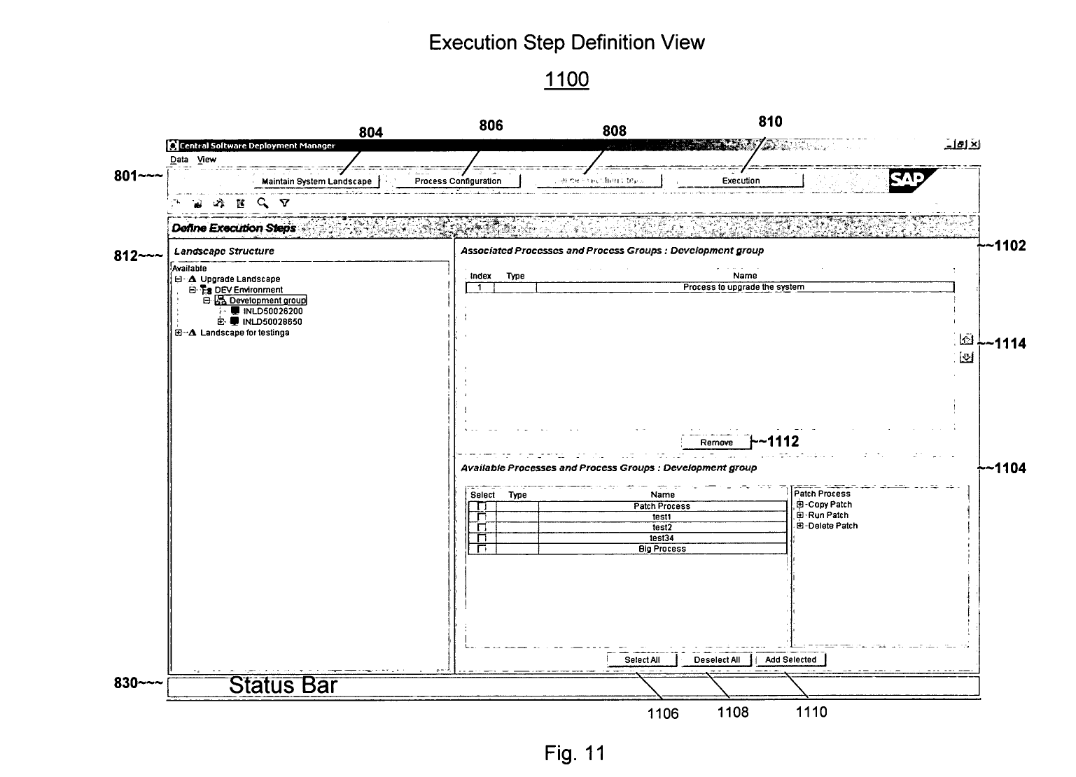

FIG. 11 depicts an execution step definition view 1100 according to one embodiment of the invention. Main window 801 may also be displayed along with execution step definition view 1100. Execution step definition view 1100 may display multiple screens to allow a user to define execution steps. Execution step definition view 1100 may include maintain system landscape screen 812, available processes and process groups screen 1104, and associated processes and process groups screen 1102. Available processes and process groups screen 1104 may display available processes and process groups. Using maintain system landscape screen 812 a user may select a system group or a system and one or more process or process group to link to define an execution step. A user may choose a select all button 1106 to select all of the displayed processes and processes groups. A user may choose a deselect all button 1108 to deselect all of the processes and process groups. If a user is satisfied with the selection, the user may choose add selected button 1110 to link the selected processes or process groups to the selected system or system group configuration. An execution step object may store information about the link. The linked processes are displayed by associated processes and process groups screen 1102. A user may scroll through these execution step definitions using scroll buttons 1114.

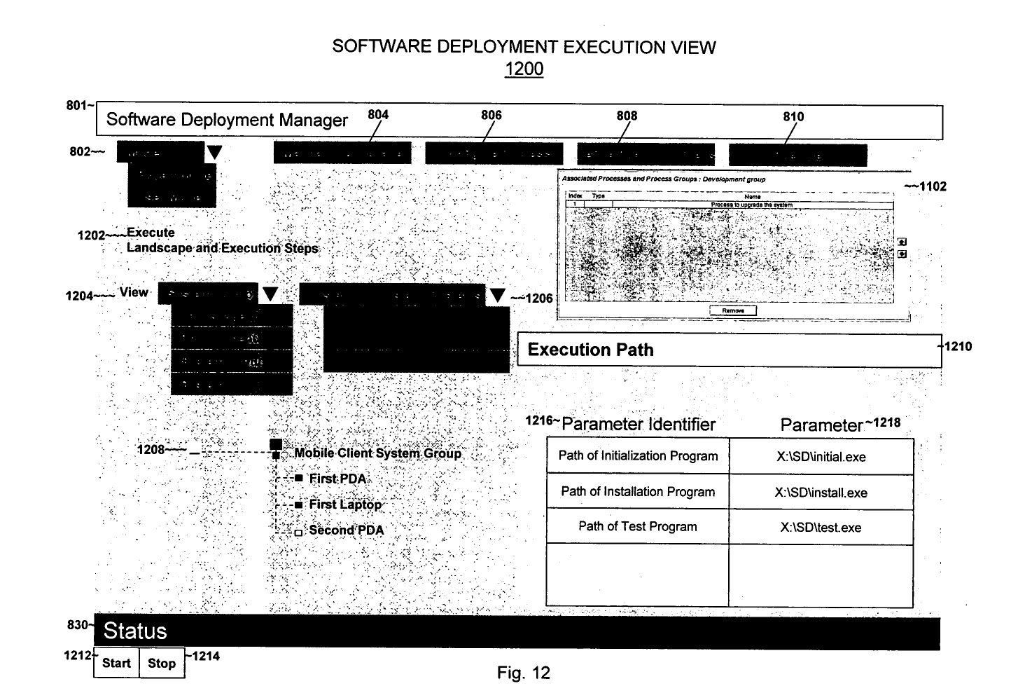

FIG. 12 depicts a software deployment execution view 1200 according to one embodiment of the invention. Main window 801 may also be displayed along with software deployment execution view 1200. Software deployment execution view 1200 may comprise execute screen 1202 and execution path screen 1210 as well as associated processes and process groups screen 1102.

Execute screen 1202 may include execute view control 1202, execute detail view control 1206, and execute entity display control 1208. Execute view control 1202 may provide a user with entity selections, such as landscape, environment, system group or system. Execute detail view control 1206 may be selected by a user to display entities at the level that was selected using execute view control 1202. When an entity is selected, a user may activate execute entity display control 1208 to display the entity selected using execute detail view control 1206 and any children of that entity. Execute detail view control 1206 and execute entity display control 1208 may retrieve information about available entities and the entity selected using entity manager 304.

Execution path screen 1210 may comprise execute parameter identifier display 1216, and execute parameter control 1218. Associated processes and process groups screen 1102 displays the process or process group that will be executed to deploy software. Additionally commands may be displayed by associated processes and process groups screen 1102 for a selected process. A user may then select a command. Execute parameter identifier display 1216 displays tags describing the parameters that need to be specified for the selected command. A user may provide the parameters using execute parameter control 1218. After the user has entered the parameter, the user selects enter on a keyboard or an execute command go button so that the system accepts the parameter that was specified. In an alternate embodiment of the invention, associated processes and process groups screen 1102 does not display commands, but allows a user to select a process or process group. Commands associated with the selected process or process group are displayed by parameter identifier 1216.

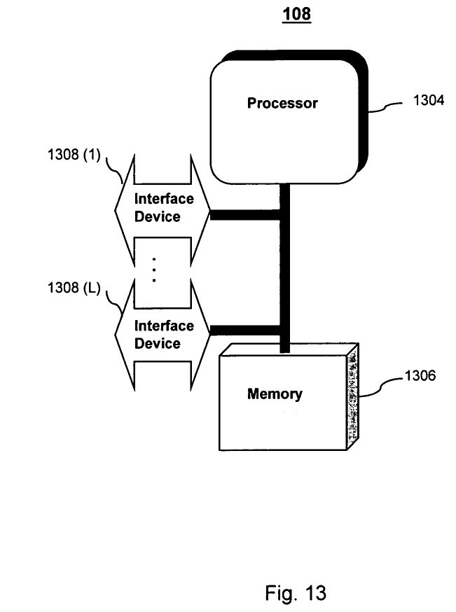

FIG. 13 shows a software deployment manager according to one embodiment of the invention. Software deployment manager 108 includes processor 1304, memory 1306, and interface devices 1308(1)-1308(L). Processor 1304 is connected to memory 1304. Processor 1304 is also connected to interface devices 1308(1)-1308(L). These connections are direct or via other internal electronic circuitry or components.

Processor 1304 is a programmable processor that executes instructions residing in memory 1306 to receive and send data via interface devices 1308(1)-1308(L). A programmable processor may be any programmable microprocessor or processor or combination of microprocessors or processors that can operate on digital data. According to one embodiment of the present invention processor 1304 is an Intel microprocessor.

Memory 1306 may be any machine-readable medium that stores data that is processed by processor 1304. Machine-readable medium may be any computer program product, apparatus and/or device (e.g., a random access memory (RAM), read only memory (ROM), magnetic disc, optical disc, programmable logic device (PLD), tape, or any combination of these devices). This may include external machine-readable mediums that are connected to processor 1304 via one or more interface devices 1308(1)-1308(L).

Interface devices 1308 (1)-1308(L) are interfaces that receive and/or send digital data to and from an external device. Interfaces may be any point of access to an external device where digital data is received or sent, including ports, buffers, queues, subsets thereof, or any other interface to an external device. Software deployment manager 108 may have administrator interface 302 connected via one or more of interface devices 1308 (1)-1308(L). Administrator interface 302 may be a graphical user interface (GUI), a phone, or a personal data assistant. Such devices may comprise an output device that can provide to a user any form of sensory feedback such as voice, auditory or tactile (e.g., liquid crystal display (LCD), cathode ray tube (CRT), or earpiece) and an input device providing any form of input to the computer including acoustic, speech, or tactile input (e.g., keyboard, mouse, trackball, keypad).

Various implementations of the systems and techniques described here can be realized in any processing systems and/or digital electronic circuitry, integrated circuitry, specially designed ASICs (application specific integrated circuits), computer hardware, firmware, software, and/or combinations thereof.

A number of embodiments of the invention have been described. Nevertheless, it will be understood that various modifications may be made.

What is claimed is:

1. An arrangement for a definition of a software deployment comprising:
a first processor;
a first memory coupled to said first processor; and
a software deployment manager residing in said first memory and executed by said first processor, said software deployment manager comprising:
a process configuration generator to generate one or more process configurations, each of said one or more process configurations comprising one or more instructions to deploy software; and
an execution process definition generator to link a selected process configuration to a system configuration representing an entity, wherein the execution process definition when executed deploys software on said entity.

2. The arrangement of claim 1, wherein said software deployment manager further comprises:
a system configuration generator to generate a system configuration to maintain information about said entity.

3. The arrangement of claim 1, wherein said software deployment manager further comprises a software deployment execution generator that initiates execution of a software deployment defined by the execution process definition generator.

4. The arrangement of claim 1, further comprising:
a second processor;
a second memory coupled to said second processor; and
a software deployment service residing in the second memory and executed by the second processor, said software deployment service comprising:
a software deployer to execute instructions received from said first processor to deploy software.

5. A graphical user interface for defining a software deployment, comprising:
a first spatial area that displays a name of an entity that was selected by a user to receive a software deployment;
a second spatial area that displays descriptions of executable units that when executed deploy software;
one or more controls that receive user input and link one or more of the executable units to the entity; and
a third spatial area that displays linked executable units upon receipt of user input.

6. The graphical user interface of claim 5, further comprising:
a fourth spatial area for displaying available systems in a network to allow selection of one of said systems to be included in an entity to receive a software deployment.

7. The graphical user interface of claim 5, further comprising:
a fourth spatial area to display names of parameters that identify locations of files to be processed to deploy software; and
a control to accept user input specifying said file locations.

8. A method for generating an execution step to deploy software comprising:
querying a network for identification of devices connected to the network;
upon receipt of a response from the network, generating an entity configuration describing one or more of the devices;
displaying said entity configuration and available executable units to a user, wherein said available executable units comprise one or more instructions that when executed deploy software; and
upon receipt of user input, linking a selected executable unit to said entity to define an execution step for deploying software on said entity.

9. The method of claim 8 wherein said executable unit comprises selected instructions including at least one instruction that should not be executed if execution of another instruction fails.

10. The method of claim 8 further comprising:
extracting an instruction to deploy software from a message, said instruction having a first format;
converting said instruction from said first format to a second format, the second format being compatible with an operating system of the local device; and
responsive to execution of the converted instruction, deploying software on the local device.

11. The method of claim 8 wherein said instruction is converted by identifying a look-up table that corresponds to a type of operating system in use at the local device.

12. The method of claim 8 further comprising:
transmitting software deployment messages from a common source to a plurality of heterogeneous computer systems;
at each of the computer systems
converting instruction within the message to a format that is compatible with an operating system in use at the respective computer system; and
responsive to execution of the converted instructions, deploying software on the respective computer system.

13. The method of claim 8 wherein the entity is a system group or system.

14. The method of claim 8 wherein the executable unit is a process group or process.

15. A computer readable medium storing thereon program instructions that, when executed, cause an executing device to:
query a network for identification of devices connected to the network;
upon receipt of a response from the network, generate an entity configuration describing one or more of the devices;
display said entity configuration and available executable units to a user, wherein said available executable units comprise one or more deployment instructions that when executed deploy software; and
upon receipt of user input, link a selected executable unit to said entity to define an execution step for deploying software on said entity.

16. The computer readable medium of claim 15 wherein said executable unit comprises selected deployment instructions including at least one deployment instruction that should not be executed if execution of another instruction fails.

17. The computer readable medium of claim 15 further comprising instructions that cause the executing device to:
extract a deployment instruction to deploy software from a message, said deployment instruction having a first format;
convert said deployment instruction from said first format to a second format, the second format being compatible with an operating system of the local device; and
responsive to execution of the converted deployment instruction, deploy software on the local device.

18. The computer readable medium of claim 15 wherein said deployment instruction is converted by identifying a look-up table that corresponds to a type of operating system in use at the local device.

19. The computer readable medium of claim 15 further comprising instructions that cause the executing device to:
transmit software deployment messages from a common source to a plurality of heterogeneous computer systems;
at each of the computer systems
convert deployment instructions within the message to a format that is compatible with an operating system in use at the respective computer system; and
responsive to execution of the converted instructions, deploy software on the respective computer system.

20. The computer readable medium of claim 15 wherein the entity is a system group or system.

21. The computer readable medium of claim 15 wherein the executable unit is a process group or process.
